(19) United States
(12) Patent Application Publication
(10) Pub. No.: US 2020/0351957 A1
(43) Pub. Date: Nov. 5, 2020

(54) TIMING SYNCHRONIZATION METHOD AND APPARATUS THEREFOR

(71) Applicant: ELECTRONICS AND TELECOMMUNICATIONS RESEARCH INSTITUTE, Daejeon (KR)

(72) Inventor: Ji Hyung KIM, Daejeon (KR)

(73) Assignee: ELECTRONICS AND TELECOMMUNICATIONS RESEARCH INSTITUTE, Daejeon (KR)

(21) Appl. No.: 16/863,105

(22) Filed: Apr. 30, 2020

(30) Foreign Application Priority Data
May 3, 2019 (KR) 10-2019-0052552
Aug. 16, 2019 (KR) 10-2019-0100477
Oct. 4, 2019 (KR) 10-2019-0123245
Apr. 20, 2020 (KR) 10-2020-0047145

(51) Int. Cl. H04W 74/08; H04L 27/26; H04W 56/00

(52) U.S. Cl. CPC H04W 74/0866; H04W 56/001; H04L 27/2665

(57) ABSTRACT

A timing synchronization method performed in a terminal may comprise receiving information on a common delay of a service link between the terminal and a base station from the base station; transmitting a physical random access channel (PRACH) preamble to the base station by reflecting the common delay with respect to a random access channel (RACH) occasion associated with a synchronization signal/physical broadcast channel (SS/PBCH) block received from the base station; receiving a first random access response (RAR) including a timing adjustment value reflecting a differential delay between the terminal and the base station from the base station; and performing uplink transmission to the base station by reflecting the common delay and the timing adjustment value.

### CROSS-REFERENCE TO RELATED APPLICATIONS

This application claims priority to Korean Patent Applications No. 10-2019-0052552 filed on May 3, 2019, No. 10-2019-0100477 filed on Aug. 16, 2019, No. 10-2019-0123245 filed on Oct. 4, 2019, and No. 10-2020-0047145 filed on Apr. 20, 2020 with the Korean Intellectual Property Office (KIPO), the entire contents of which are hereby incorporated by reference.

### BACKGROUND

### 1. Technical Field

The present disclosure relates to a technique for timing synchronization in a communication system, and more specifically, to a method for timing synchronization between a terminal and a base station in long-distance communications, and an apparatus for the same.

### 2. Related Art

There is a need to develop mobile satellite communication technologies to prepare for disruption of communication that may occur in cellular network shadow areas such as mountainous areas, desert areas, islands, and oceans and terrestrial network collapsed areas due to earthquakes, tsunamis, and wars. The satellite communication network is maintained even when the terrestrial network is collapsed due to disasters, so that the area where the disasters occur can be connected to the outside, and individual survival and safety can be maintained.

In addition, the necessity of mobile satellite communication technologies is increasing for construction of a hyper-connected society that provides mobile communication services even in areas where communication has not been possible in the past, such as mountains and remote areas without a communication infrastructure.

In the 3rd generation partnership project (3GPP), based on 5G new radio (NR) technology, standardization of non-terrestrial networks (NTNs) using a non-terrestrial base station (e.g., a base station using an airborne platform such as a satellite or an airship) is being progressed. Meanwhile, when the non-terrestrial base station is a satellite base station, the distance between the satellite base station and a terminal may be a long distance, and the position of the satellite base station may be continuously changed.

The non-terrestrial network has a relatively long round trip time delay and a high Doppler shift environment compared to terrestrial communications. Since the long round trip time delay affects various procedures of data transmission/reception, when appropriate timing adjustments are not performed at terminals, arrival time points of signals from the terminals located at various distances may have a great difference at the base station. Accordingly, there is a need for a method for timing synchronization or adjustment suitable for long-distance communications, and a method for reducing overhead of control parameters therefor.

### SUMMARY

Accordingly, exemplary embodiments of the present disclosure provide a method for timing synchronization in a communication system.

Accordingly, exemplary embodiments of the present disclosure also provide an apparatus for timing synchronization in a communication system.

According to a first exemplary embodiment of the present disclosure, a timing synchronization method performed in a terminal belonging to a mobile communication network may comprise receiving information on a common delay of a service link between the terminal and a base station from the base station; transmitting a physical random access channel (PRACH) preamble to the base station by reflecting the common delay with respect to a random access channel (RACH) occasion associated with a synchronization signal/physical broadcast channel (SS/PBCH) block received from the base station; receiving a first random access response (RAR) including a timing adjustment value reflecting a differential delay between the terminal and the base station from the base station; and performing uplink transmission to the base station by reflecting the common delay and the timing adjustment value.

The common delay may be determined based on at least one of a shortest distance between the terminal and the base station in coverage of the base station to which the terminal belongs, an average distance between the terminal and the base station in the coverage, a longest distance between the terminal and the base station in the coverage, a point where a signal-to-noise ratio (SNR) of a signal transmitted from the base station is highest in the coverage, a point where an azimuth angle of a beam transmitted to the base station in the coverage is 0°, and a center point of the beam.

The timing adjustment value may additionally reflect a timing offset TAoffset in addition to the differential delay.

The information on the common delay may be configured as a value specific to the base station, a value specific to a cell of the base station, or a value specific to a beam of the base station.

The information on the common delay may be received as included in a master information block (MIB), system information block 1 (SIB1), other system information (OSI), or a newly defined SIB.

The receiving of the information on the common delay may comprise receiving table-type information including at least one value of the common delay from the base station through higher layer signaling; and receiving index information indicating one common delay value among the at least one value of the common delay from the base station.

The uplink transmission may be a Msg3 of a 4-step RACH procedure, and the terminal may adjust a time point of the uplink transmission based on a difference between a timing adjustment value received through a previous RAR different from the first RAR and the timing adjustment value received through the first RAR.

The mobile communication network may be a non-terrestrial network (NTN), and the base station may be a satellite base station or an unmanned aerial vehicle (UAV) on-board base station.

According to a second exemplary embodiment of the present disclosure, a timing synchronization method performed in a base station belonging to a mobile communication network may comprise transmitting information on a common delay of a service link between the base station and a terminal to the terminal; receiving a physical random access channel (PRACH) preamble from the terminal, the PRACH preamble being transmitted by reflecting the common delay with respect to a random access channel (RACH) occasion associated with a synchronization signal/physical broadcast channel (SS/PBCH) block transmitted to the terminal; transmitting a first random access response (RAR) including a timing adjustment value reflecting a differential delay between the terminal and the base station to the terminal; and receiving uplink transmission from the terminal, the common delay and the timing adjustment value being reflected to the uplink transmission.

The common delay may be determined based on at least one of a shortest distance between the terminal and the base station in coverage of the base station to which the terminal belongs, an average distance between the terminal and the base station in the coverage, a longest distance between the terminal and the base station in the coverage, a point where a signal-to-noise ratio (SNR) of a signal transmitted from the base station is highest in the coverage, a point where an azimuth angle of a beam transmitted to the base station in the coverage is 0°, and a center point of the beam.

The timing adjustment value may additionally reflect a timing offset TAoffset in addition to the differential delay.

The information on the common delay may be configured as a value specific to the base station, a value specific to a cell of the base station, or a value specific to a beam of the base station.

The information on the common delay may be transmitted as included in a master information block (MIB), system information block 1 (SIB1), other system information (OSI), or a newly defined SIB.

The transmitting of the information on the common delay may comprise transmitting table-type information including at least one value of the common delay to the terminal through higher layer signaling; and transmitting index information indicating one common delay value among the at least one value of the common delay to the terminal.

The uplink transmission may be a Msg3 of a 4-step RACH procedure, and the terminal may adjust a time point of the uplink transmission based on a difference between a timing adjustment value received through a previous RAR different from the first RAR and the timing adjustment value received through the first RAR.

The mobile communication network may be a non-terrestrial network (NTN), and the base station may be a satellite base station or an unmanned aerial vehicle (UAV) on-board base station.

According to a third exemplary embodiment of the present disclosure, a terminal belonging to a mobile communication network may comprise a processor; and a memory storing at least one instruction executable by the processor, wherein when executed by the processor, the at least one instruction causes the processor to receive information on a common delay of a service link between the terminal and a base station from the base station; transmit a physical random access channel (PRACH) preamble to the base station by reflecting the common delay with respect to a random access channel (RACH) occasion associated with a synchronization signal/physical broadcast channel (SS/PBCH) block received from the base station; receive a first random access response (RAR) including a timing adjustment value reflecting a differential delay between the terminal and the base station from the base station; and perform uplink transmission to the base station by reflecting the common delay and the timing adjustment value.

The common delay may be determined based on at least one of a shortest distance between the terminal and the base station in coverage of the base station to which the terminal belongs, an average distance between the terminal and the base station in the coverage, a longest distance between the terminal and the base station in the coverage, a point where a signal-to-noise ratio (SNR) of a signal transmitted from the base station is highest in the coverage, a point where an azimuth angle of a beam transmitted to the base station in the coverage is 0°, and a center point of the beam.

The information on the common delay may be received as included in a master information block (MIB), system information block 1 (SIB1), other system information (OSI), or a newly defined SIB.

The uplink transmission may be a Msg3 of a 4-step RACH procedure, and the terminal may adjust a time point of the uplink transmission based on a difference between a timing adjustment value received through a previous RAR different from the first RAR and the timing adjustment value received through the first RAR.

According to the exemplary embodiments of the present disclosure, the timing synchronization between the base station and the terminal can be effectively maintained by reflecting the common delay between the base station and the terminals, and thus the performance of the communication system can be improved.

### BRIEF DESCRIPTION OF DRAWINGS

Exemplary embodiments of the present disclosure will become more apparent by describing in detail embodiments of the present disclosure with reference to the accompanying drawings, in which:

FIG. 1 is a conceptual diagram illustrating concepts of a common delay and a differential delay according to a position of a terminal in long-distance communication;

FIG. 2 is a conceptual diagram illustrating a concept in which a common delay is defined for a specific beam;

FIG. 3 is a conceptual diagram for describing various common delays existing in a non-terrestrial network environment;

FIG. 4 is a conceptual diagram illustrating beam (or cell) coverages of a base station operating multiple beams; and

FIG. 5 is a block diagram illustrating a configuration of an apparatus for performing a timing synchronization method for long-distance communication according to an exemplary embodiment of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

Exemplary embodiments according to the present disclosure provide a timing synchronization method and a timing synchronization apparatus suitable for long-distance communications. In the following, the exemplary embodiments according to the present disclosure will be described with reference to the 3GPP new radio (NR) mobile communication system, and reference is made to the following documents, which specify the operations of the 3GPP NR mobile communication system.

Reference 1: 3GPP TS 38.211 V15.5.0, “3rd Generation Partnership Project; Technical Specification Group Radio Access Network; NR; Physical channels and modulation (Release 15)” March 2019.

Reference 2: 3GPP TS 38.212 V15.5.0, “3rd Generation Partnership Project; Technical Specification Group Radio Access Network; NR; Multiplexing and channel coding (Release 15)” March 2019.

Reference 3: 3GPP TS 38.213 V15.5.0, “3rd Generation Partnership Project; Technical Specification Group Radio Access Network; NR; Physical layer procedures for data (Release 15)”, March 2019.

Reference 4: 3GPP TS 38.214 V15.5.0, “3rd Generation Partnership Project; Technical Specification Group Radio Access Network; NR; Physical layer procedures for data (Release 15)”, March 2019.

Reference 5: 3GPP TS 38.331 V15.5.1, “3rd Generation Partnership Project; Technical Specification Group Radio Access Network; NR; Radio Resource Control (RRC) protocol specification (Release 15)”, March 2019.

Reference 6: 3GPP TR 38.811 V15.0.0, “3rd Generation Partnership Project; Technical Specification Group Radio Access Network; Study on New Radio (NR) to support non terrestrial networks (Release 15)”, June. 2018.

Reference 7: 3GPP TS 38.821 V0.4.0, “3rd Generation Partnership Project; Technical Specification Group Radio Access Network; Solutions for NR to support non-terrestrial networks (NTN) (Release 16)”, March 2019.

Reference 8: 3GPP TR 22.829 V1.0.0, “3rd Generation Partnership Project; Technical Specification Group Radio Access Network; Study on Enhancement for Unmanned Aerial Vehicles; Stage 1 (Release 17)”, March 2019.

Hereinafter, a ‘base station’ may be a conventional base station in terrestrial communication or a satellite base station described in Reference 6. In this case, the satellite base station may be a transparent satellite (e.g., high-altitude platform station system (HAPS), low earth orbit (LEO), medium earth orbit (MEO), geostationary equatorial orbit (EO), etc.) or a regenerative satellite (e.g., HAPS, LEO, MEO, GEO, etc.) described in Reference 6. For convenience of description, the ‘satellite base station’ may be used as a term representing a non-terrestrial base station or a mobile base station. However, the exemplary embodiments described below may be applied not only to the satellite base station, but also to a base station mounted in an unmanned aerial vehicle (UAV) (i.e., UAV on-board base station (UBS)) described in Reference 8.

When considering long-distance communication, such as the non-terrestrial network (NTN) environment, which is currently being standardized in the 3GPP, as a cell radius and an altitude of the base station (e.g., satellite base station) increase, a very large difference may exist among signal arrival times according to the positions of the terminals.

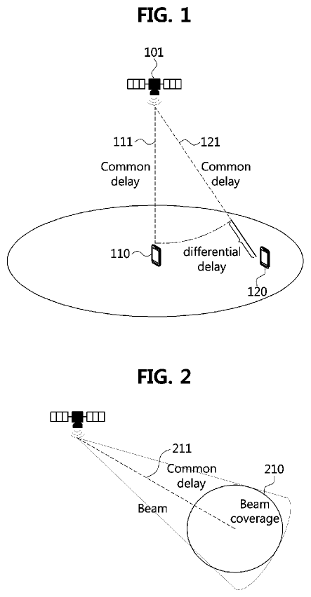

FIG. 1 is a conceptual diagram illustrating concepts of a common delay and a differential delay according to a position of a terminal in long-distance communication.

Referring to FIG. 1, in a coverage of the satellite base station 101, a delay (i.e., common delay) according to a distance 111 between the satellite base station 101 and a terminal 110 located in a vertical direction from the satellite base station 101, and a delay (i.e., common delay+differential delay) according to a distance 121 between a terminal 120 located at various points and the satellite base station 101 are shown.

That is, the delay of the terminal 110 and the delay of the terminal 120 may have a difference by a differential delay. In this case, an arrival time at the satellite base station 101 of a signal transmitted from the terminal 110 and an arrival time at the satellite base station 101 of a signal transmitted from the terminal 120 may have a difference by the differential delay.

That is, the common delay may be a one-way delay according to the shortest distance, the average distance, or the longest distance between the base station and the terminal at a specific time point, or a specific value (e.g., altitude of the satellite) defined by the base station (or, system).

FIG. 2 is a conceptual diagram illustrating a concept in which a common delay is defined for a specific beam.

Referring to FIG. 2, with respect to a beam of the base station, the common delay may be defined as a delay at a center point of the beam (i.e., a point where an azimuth angle of the beam is 0°, a point where the beam has the greatest gain, or a boresight point of the beam) or a delay at a point where the beam has the greatest signal-to-noise ratio (SNR) in the corresponding coverage.

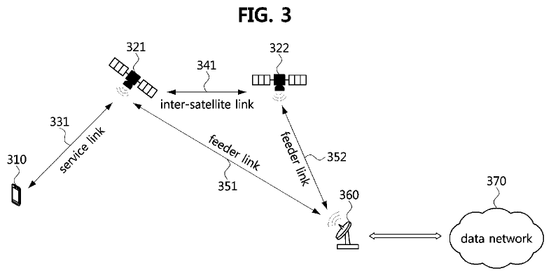

FIG. 3 is a conceptual diagram for describing various common delays existing in a non-terrestrial network environment.

Referring to FIG. 3, at least three types of radio links may exist in a non-terrestrial network environment. The at least three types of radio links may include a service link 331 between a terminal 310 and a satellite base station 321, an inter-satellite link (ISL) 341 between the satellite base station 321 and a satellite base station 322, and feeder links 351 and 352 among the satellite base stations 321 and 322 and a terrestrial gateway 360 connected to a data network 370.

In this case, a common delay D_{S} of the service link, a common delay D_{I} of the inter-satellite link, and a common delay D_{F} of the feeder link may exist, and the common delays described in FIGS. 1 and 2 mainly correspond to the common delay D_{S} of the service link.

Common Delay (i.e., Common TA) Signaling Method

A common timing advance (TA) may be defined in consideration of the common delay. The common TA may be calculated as a one-way common delay (i.e., round-trip delay time/2) of a coverage (e.g., coverage of one beam or one cell) of the base station or a two-way common delay. Here, there may be a plurality of beams in one cell. Hereinafter, the common delay may also be referred to as the common TA.

The common delay described in FIG. 1 may correspond to a common delay at the point where the distance between the base station and the terminal is the shortest. Meanwhile, the differential delay in FIG. 1 may represent a remaining value excluding the common delay from a one-way transmission delay between the terminal and the base station. On the other hand, the base station may configure the common TA to be an arbitrary value regardless of the above-described definitions, and a method for the base station to configure the common TA as an arbitrary value may vary according to the implementation of the base station. The common TA may be a value that the base station signals to terminals belonging to the coverage of the base station, and may be signaled in various schemes described below.

In an exemplary embodiment, the common TA may be signaled through reserved bits of a master information block (MIB) of Reference 5 or bits additionally defined in the MIB. In this case, the terminal may receive a synchronization signal/physical broadcast channel (SS/PBCH) block from the base station, and obtain information on the common TA by acquiring the MIB from the received SS/PBCH block.

In another exemplary embodiment, the common TA may be signaled through reserved bits of a system information block 1 (SIB1) of Reference 5 or bits additionally defined in the SIB1. In this case, the terminal may receive an SS/PBCH block from the base station, acquire the SIB1 by using control resource set (CORESET) information included in the SS/PBCH block, and obtain information on the common TA. For example, the information on the common TA may be transmitted as included in ServingCellConfigCommon included in the SIB1, or a parameter n-TimingAdvanceOffset of the ServingCellConfigCommon may be transmitted as a value reflecting the common TA.

In yet another exemplary embodiment, the common TA may be signaled through reserved bits of other system information (OSI) of Reference 5 (i.e., SIBs other than the SIB1) or bits additionally defined in the OSI. In this case, the terminal may receive an SS/PBCH block, acquire the SIB1 by using CORESET information included in the SS/PBCH block, acquire the OSI by referring to the SIB1, and obtain information on the common TA. Alternatively, the terminal may receive an SS/PBCH block, acquire the OSI by using the CORESET information included in the SS/PBCH block, and obtain information on the common TA.

In yet another exemplary embodiment, the common TA may be signaled through a newly defined SIB (hereinafter referred to as ‘nSIB’). In this case, the nSIB may include only information on the common TA or may include information of the base station (e.g., an identifier (ID) of the base station or information associated with a beam ID) together with the common TA. In this case, the terminal may receive an SS/PBCH block, acquire the SIB1 using CORESET information included in the SS/PBCH block, acquire the nSIB by referring to the SIB1, and obtain information on the common TA from the nSIB. Alternatively, the terminal may receive an SS/PBCH block, acquire the nSIB using the CORESET information included in the SS/PBCH block, and obtain information on the common TA from the nSIB.

Based on information on an operating frequency band or information on a public land mobile network (PLMN) identified through reception of the SS/PBCH block, the terminal may identify which type of communication the base station transmitting the corresponding SS/PBCH block performs (e.g., whether or not the base station belongs to a non-terrestrial network), identify whether to obtain the common TA, and identify information on a scheme in which the common TA is to be obtained.

Meanwhile, even when an update for the configured common TA is required, a new common TA may be signaled according to an update periodicity of the MIB, the SIB1, the OSI, and the nSIB described above. Alternatively, the common TA value to be updated may be signaled using at least one of radio resource control (RRC) signaling, a medium access control (MAC) control element (CE), or downlink control information (DCI).

Meanwhile, for measurement or handover, information related to a common TA of a neighboring base station or a neighboring cell may be signaled to the terminal as included in a measurement gap or an SS/PBCH block measurement time configuration (SMTC). Alternatively, the information related to a common TA of a neighboring base station or a neighboring cell may be signaled to the terminal using newly defined RRC signaling (parameters).

Composition of Common TA Information

The common TA is a parameter for the coverage of the base station as described above. In an exemplary embodiment, when the common TA is a base station-specific parameter, the common TA may be configured as one fixed value per base station regardless of the coverage. In another exemplary embodiment, when the common TA is a cell-specific parameter, the common TA may be configured as one value per cell, and may be configured as a fixed value or a value that changes over time. When the base station manages multiple cells, the base station may have multiple common TA values. In yet another exemplary embodiment, when the common TA is a beam-specific parameter, the common TA may be configured as one value per beam, and may be configured as a fixed value or a value that changes over time.

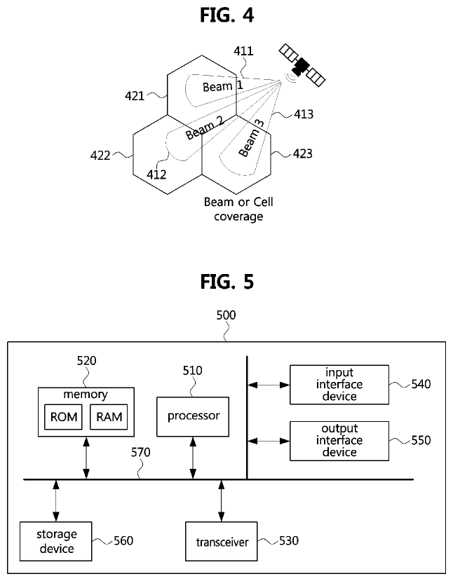

FIG. 4 is a conceptual diagram illustrating beam (or cell) coverages of a base station operating multiple beams.

Referring to FIG. 4, coverage per beam or per cell may be configured. For example, coverages 421, 422, and 423 may be configured for beams 411, 412, and 413, respectively. Alternatively, there may be multiple beams in one cell. When multiple beams exist in one cell, there may be multiple common TA values per cell, and multiple common TA values per base station. When a common TA exists for each beam, a common TA corresponding to a beam may be identified by a mapping relationship between beams and SS/PBCH block indexes.

Hereinafter, configuration of ‘common TA information’, which is a form in which the common TA is signaled, will be described.

In the case that the common TA is base station-specific or cell-specific, one or more information units each of which is (common TA), (base station ID, common TA), (cell ID, common TA), or (base station ID, cell ID, common TA) may be signaled to the terminal by at least one of the aforementioned signaling schemes.

In the case that the common TA is beam-specific, one or more information units each of which is (SS/PBCH block index and/or beam index, common TA) may be signaled to the terminal by at least one of the aforementioned signaling schemes. In addition, the base station ID or cell ID may be additionally signaled to the terminal. Here, the SS/PBCH block index may be an index indicated by a PBCH and a DMRS of the PBCH as described in References 1 and 3. The SS/PBCH block index may be the same as or different from the beam index. The beam index may be an index that identifies a beam.

The terminal may assume that the beam index and the SS/PBCH block index are the same, or may obtain a mapping relationship between beams and SS/PBCH blocks and/or beam management (BM) channel state information reference signals (CSI-RSs) through the above-described signaling method of the common TA or through other signaling (e.g., RRC, MAC-CE, or DCI).

When the common TA information does not include the SS/PBCH block index but only the beam index, or when the common TA information includes only the common TA, the terminal may sequentially map the SS/PBCH block index and the common TA implicitly. For example, the terminal may arrange the common TAs in the order of SS/PBCH block indexes. Alternatively, when the common TA information is configured as (SS/PBCH block index, common TA), the terminal may ignore the beam index. Also, a common TA may be configured for each SS/PBCH block, or one representative common TA may be configured for all SS/PBCH blocks.

When beam switching occurs due to a beam failure or movement of the terminal and/or the base station, the terminal may request a new common TA to the base station through on-demand system information (SI) request procedure, and the base station may signal the new common TA to the terminal by one of the above-described signaling schemes. When the base station signals a new transmission configuration indicator (TCI) to the terminal in the beam failure situation, a corresponding channel in the CORESET may include information on the new common TA.

Meanwhile, a plurality of common TA values may configured in form of a table (or list), and the base station may indicate to the terminal one of the common TA values configured in the table (or list) by using an index. For example, common TA values for distances between the terminal and the base station, ranging from A km to C km and having an interval of B km, may be generated in form of a table, and the generated table may be delivered to the terminal through higher layer signaling (e.g., RRC signaling) or may be delivered to the terminal in offline (e.g., stored in a memory of the terminal). In this case, the base station may transmit an index (e.g., D bits) indicating a specific common TA in the delivered (stored) table to the terminal.

For example, in consideration of an operating altitude of the satellite equipped with the base station, common TA values may be preconfigured with an interval of 1 km for a distance range of 50 to 100 km, common TA values may be preconfigured with an interval of 1 km for a distance range of 500 to 1200 km, and common TA values may be preconfigured with an interval of 1 km for a distance range of 35000 to 36,000 km. In addition, an index value indicating a specific common TA in the table in which the preconfigured common TA values are stored may be composed of 12 bits.

The table may be configured by mapping a common TA value with a base station ID, a cell ID, a beam index, or an SS/PBCH index, and may be included in the SIB1 or the OSI and signaled from the base station to the terminal.

Meanwhile, the corresponding value of the common TA may be directly expressed using w1 bits, or may be expressed using y1 bits obtained by quantizing the corresponding value of w1 bits with an interval of x1 bits. This may be expressed according to a subcarrier spacing and a basic time unit T_{c} defined in Reference 1. For example, w1, x1, and y1 may be 14, 2, and 12, respectively. When the base station needs to signal a plurality of common TA values (including the above-described case of having multiple common TA values), each value may be directly expressed using w1 bits, or may be represented using y1 bits obtained by quantizing the corresponding value of w1 bits with an interval of x1 bits.

Alternatively, one specific value (i.e., representative value) may be represented directly using w1 bits, or may be represented using y1 bits obtained by quantizing the corresponding value of w1 bits with an interval of x1 bits. The remaining common TA values may be represented using differences from the representative value, each of which is expressed directly using w2 bits, or is expressed using y2 bits obtained by quantizing the corresponding value of w2 bits with an interval of x2 bits. Here, w2 and y2 may be smaller than or equal to w1 and y1, respectively. For example, w2, x2, and y2 may be 12, 4, and 10.

In this case, the representative value may be defined as a base station-specific or cell-specific parameter. When the representative value is a base station-specific parameter or a cell-specific parameter, the representative value may be set to a fixed value. When the terminal knows the type of the satellite on which the base station is mounted (or the PLMN and the corresponding frequency band of the base station), the fixed value may be set to a value (e.g., satellite altitude) known in offline. In this case, the common TA information may be configured only for the difference from the representative value. The representative value may be indicated as an index to the above-described table.

When the common TA is beam-specific, a representative value for a group of one or more beams may be configured without configuring a common TA for each beam. For example, when the number of beams or all SS/PBCH blocks is S1, CS1 common TA values may be configured. CS1 may be less than or equal to S1. The base station may transmit to the terminal information of the above-described mapping relationship of (SS/PBCH index, common TA) for the mapping relationship between S1 and CS1. Since all beams or SS/PBCH blocks are mapped to the same common TA when CS1 is 1, the base station may not signal the corresponding mapping relationship to the terminal.

In an exemplary embodiment, the common TA may be configured for a specific subcarrier spacing (e.g., 30 kHz or 240 kHz). When a subcarrier spacing actually used is different from the specific subcarrier spacing, the terminal may convert the configured common TA value to a value corresponding to the subcarrier spacing actually used, and apply the converted common TA value.

So far, the common TA has been defined only for the common delay D_{S} for the service link. However, in an exemplary embodiment, the common TA may be configured for a combination of at least one of D_{S}, D_{I}, and D_{F}. That is, the common TA may be configured as (D_{S}+D_{I}+D_{F}), (D_{S}+D_{F}), or (D_{S}+D_{I}). Alternatively, the common TA may be configured for each common delay. For example, the common TA may represent D_{S}, D_{I}, and D_{F}, respectively. Each value may be configured by a higher layer parameter (RRC or MAC-CE) to the terminal, and may be notified to the terminal by using DCI, a higher layer parameter, the MIB, the SIB1, or the OSI. Alternatively, for example, D_{S} may be notified to the terminal by using the MIB, the SIB1, or the OSI, and the remaining values may be notified by a higher layer parameter.

When a plurality of D_{S} (e.g., D_{S_i}=0, . . . , CS1) exist according to the SS/PBCH block or the beam, a combination (D_{S_i}, D_{I}, D_{F}) for each i may be configured. In this case, through a higher layer parameter (e.g., RRC or MAC-CE) or DCI, the base station may inform the terminal of information on which combination is signaled and information on which combination is suitable for a procedure. The terminal may configure and apply a new combination using the combination of (D_{S}, D_{I}, D_{F}) received from the base station according to a method applied to the corresponding common TA.

When the terminal estimates a common TA, the terminal may estimate the common TA by using D_{I} and D_{F} received from the base station. For example, when D_{S}, D_{I}, and D_{F} are respectively received, a common TA suitable for a procedure to which the common TA should be applied may be obtained by combining (D_{S}+D_{I}+D_{F}), D_{S}, or (D_{S}+D_{F}). For example, in case of a procedure between the terminal and the base station, which is applied to the service link, D_{S} may be considered as the common TA.

RACH Procedure Using Common TA

The common TA signaled by the base station to the terminal may be defined as a round-trip (two-way) common delay rather than a one-way common delay. When the common TA signaled by the base station to the terminal indicates a one-way common delay, the terminal may calculate a 2×common TA and reflect it in determining a transmission time point. When the common TA signaled by the base station to the terminal indicates a round-trip common delay, the terminal may immediately reflect the corresponding value in determining a transmission time point. Hereinafter, a case in which the common TA signaled by the base station to the terminal indicates a round-trip common delay will be described.

After obtaining the common TA, the terminal may transmit a physical random access channel (PRACH) preamble for initial access. The PRACH preamble may be transmitted according to a RACH occasion associated with a corresponding SS/PBCH block. Based on time synchronization estimated through the SS/PBCH block, the terminal may transmit the PRACH preamble as earlier as the common TA than a starting time point of the RACH occasion (e.g., (subframe, symbol) in a table disclosed in section 6.3.3.2 of Reference 1). Meanwhile, the terminal may start a monitoring window for receiving a random access response (RAR) after the common TA from the transmission of the PRACH preamble. A mapping relationship may be needed between the time point at which the terminal transmits the PRACH preamble and a time point at which the base station transmits the RAR in response to the PRACH preamble. In other words, based on the time synchronization estimated through the SS/PBCH block, the terminal may transmit the PRACH preamble as earlier as the common TA than the starting time point of the corresponding RACH occasion, or transmit the PRACH preamble at the starting time point of the corresponding PRACH occasion without transmitting the PRACH preamble earlier. This may be specified according to a procedure of the base station and the terminal, and the base station may configure a timing adjustment value in consideration of this. After receiving the PRACH preamble transmitted by the terminal, the base station may configure a timing adjustment value reflecting (differential delay described in FIG. 1+TAoffset) or (differential delay described in FIG. 1) excluding the common TA, and transmit the RAR including the configured timing adjustment value. Here, the TAoffset may correspond to the n-TimingAdvance Offset described in References 1 and 3, and the base station may signal the corresponding value to the terminal by including it in the common TA information as in the above-described signaling schemes of the common TA information, or may define the common TA itself as (common TA+TAoffset). On the other hand, the base station may not apply the TAoffset value. When the terminal obtains the common TA together with the TAoffset directly and implicitly in the manner described above, the terminal may transmit the PRACH preamble as earlier as (common TA+TAoffset) than the starting time point of the RACH occasion. In this case, after receiving the PRACH preamble, the base station may configure the timing adjustment value by using only the differential delay, excluding the (common TA+TAoffset), and transmit the RAR including the configured timing adjustment value.

On the other hand, the differential delay may be derived by using a common TA different from the common TA that was applied to the transmission of the PRACH preamble at the terminal. In other words, when a plurality of common TAs are configured through a higher layer parameter (e.g., RRC or MAC-CE) as described above, even if the terminal transmits the PRACH preamble based on a specific common TA, the base station may configure the timing adjustment value by using a differential delay derived based on a common TA different from the specific common TA. In this case, the base station may inform the terminal of the common TA that the base station uses for the derivation of the differential delay through an index or a value, and the index or value may be signaled to the terminal by using DCI or the RAR. The index may be an index indicating a common TA of the table configured by the higher layer parameter.

Meanwhile, when the terminal needs to apply D_{F} and D_{I} described above and they are not additionally signaled to the terminal, values corresponding thereto may also be included in the RAR. These may be signaled as being included as one value (summed value) in the differential delay, or may be signaled to the terminal as being included as independent values.

When the timing adjustment value signaled by the terminal as included in the RAR is (differential delay+TAoffset) or (differential delay), the terminal may change a TA applied to uplink transmission after the RAR to (common TA+differential delay+TAoffset) or (common TA+differential delay).

Meanwhile, in the case of the 2-step RACH procedure, when the terminal transmits a Message A (msgA), the above-described method of determining the transmission time point of the PRACH preamble may be applied.

In case of a terminal having capability to estimate its own location and a location of the base station or capability to estimate a universal clock through a satellite, the terminal may use the above-described procedure in the same manner. That is, the corresponding terminal may estimate (common delay+differential delay), and the terminal may transmit the PRACH preamble as earlier as the estimated (common delay+differential delay) than the starting time point of the RACH occasion. In this case, the estimated (common delay+differential delay) may also include the above-described TAoffset. That is, the terminal may estimate (common delay+TAoffset+differential delay) based on its location and the location of the base station.

The base station may identify the capability of the terminal (i.e., distinguish the terminal that knows the location information and the terminal that does not know the location information) by receiving the PRACH preamble, and for this purpose, the RACH occasion (i.e., resource location or sequence value) may be classified according to the capability of the terminal. The terminal may transmit a PRACH preamble using a RACH occasion corresponding to its capability. To this end, the terminal may identify the RACH occasion for transmission of the PRACH preamble according to the capability of the terminal. The base station may signal to the terminal a parameter indicating whether to distinguish the RACH occasion for transmission of the PRACH preamble according to the capability of the terminal, by including the parameter in rach-ConfigCommon of Reference 5 or the nSIB described above.

The terminal may report its capability information to the base station in order to enable the base station to identify the capability of the terminal (i.e., whether the terminal can obtain the location information). For example, in the case of the 4-step RACH procedure, the terminal may report its capability information to the base station by including its capability information in a Message 3 (Msg3). Alternatively, in the case of the 2-step RACH procedure, the terminal may report its capability information to the base station by including its capability information in a data part of a Message A (msgA). In addition, the terminal may report an accurate delay (i.e., the estimated value+the timing adjustment value received in the RAR) to the base station by including it in the Msg3 or the msgA.

Meanwhile, the timing adjustment value N_{TA} signaled by the base station as included in the RAR may be configured using an index from 0 to 3846. The timing adjustment value may be expressed by Equation 1 below.

N_{TA}=TA_{R}·16·64/2^{u} [Equation 1]

Here, TA_{R} is an index having a value from 0 to 3846, and μ is an index according to the subcarrier spacing (Reference 3). As described above, when the terminal transmits the PRACH preamble as earlier as the common TA signaled by the base station or the value estimated by the terminal (i.e., (common delay+differential delay) or (common delay+TAoffset+differential delay)) than the RACH occasion, the PRACH preamble may arrive at the base station earlier than an arrival time expected by the base station due to the definition or estimation error of the common TA. By reflecting the case where the PRACH preamble arrives at the base station earlier than the arrival time expected by the base station, TA_{R} may be interpreted as representing values of −X1 to X2 so that both positive and negative values can be expressed. In this case, index values 0 to 3846 of TA_{R} may be mapped to values from −X1 to X2. Here, X1 and X2 may be configured in consideration of a range of a time by which the PRACH preamble can arrive earlier than the expected arrival time and a range of the differential delay that the terminal may have.

Alternatively, the terminal may transmit the PRACH preamble as later as X3 than the time point to which the above-described common TA or the value estimated by the terminal (i.e., (common delay+differential delay) or (common delay+TAoffset+differential delay)) is applied. That is, the terminal may transmit the PRACH preamble not as earlier as (common TA+TAoffset) or (common TA) than the RACH occasion, but as earlier as (common TA+TAoffset−X3) or (common TA−X3) than the RACH occasion. In addition, as described above, in the case of the terminal having the capability to know its location and the location of the base station, the terminal may transmit the PRACH preamble not as earlier as the estimated (common delay+differential delay) or (common delay+TAoffset+differential delay) than the RACH occasion, but as earlier as (common delay+differential delay−X3) or (common delay+TAoffset+differential delay−X3) than the RACH occasion. The base station may signal X3 to the terminal together with the common TA or individually through an SIB or RRC parameter. When X3 is not signaled by the base station but is configured by the terminal, the terminal may signal X3 to the base station by including X3 in the Msg3 or msgA.

Meanwhile, when the terminal receive an SS/PBCH block and then transmits a RACH preamble on a RACH occasion determined based on the received SS/PBCH block, a RAR monitoring window of the terminal may start after a time G1 from the transmission of the RACH preamble. In the case of the 4-step RACH procedure, a monitoring window of the Msg4 may start after the time G1 from the transmission of the Msg3. In the case of the 2-step RACH procedure, a monitoring window of the MsgB may start after the time G1 from the transmission of the MsgA. In addition, G1 may be applied to a common scheduling offset per beam or per cell required for a procedure of allocating resources to the terminal. In addition, G1 may also be applied to a monitoring time for the base station's reaction to selection of a new beam after beam switching or a beam failure (i.e., the base station's response to a TCI that the terminal reports to the base station after selection).

When the terminal does not know its location information, G1 may be the common TA. When the terminal can estimate the delay by knowing its location and the location of the satellite, G1 may be (common TA), (common TA+differential delay), or (common TA+differential delay−X3). G1 for the new beam selection may be (common TA), (common TA+differential delay), or (common TA+differential delay−X3).

For the operation of the terminal, the base station may signal a maximum differential delay that the terminal can have per beam or per cell to the terminal through an MIB, SIB, or RRC parameter.

TA Update

The TA value signaled by the base station to the terminal may be changed due to the movement of the base station or the movement of the terminal. For example, in the case of the 4-Step RACH procedure, the terminal transmits the Msg3 by applying the TA value received through the RAR, but a case where the TA value applied to the transmission of the Msg3 becomes different from an actual TA value due to the movement of the terminal or the base station may occur. In this case, the base station may not receive the Msg3 normally. In particular, when a high subcarrier spacing is applied, the above-described case may occur more frequently. Therefore, there is a need to change the TA according to the movement of the base station or terminal, or to prevent the occurrence of the above-described case.

To this end, the base station may inform the terminal of a common Doppler shift. The common Doppler shift may be a cell-specific value, a base station-specific value, or a beam-specific value, similarly to the common TA described above, and may be signaled to the terminal through the MIB, SIB, or OSI. Alternatively, it may be signaled to the terminal as included in the RAR. The common Doppler shift may be signaled in the same manner as the common TA.

In order to minimize the change of the above-described TA, the terminal and the base station may restrict the subcarrier spacing applied during the execution of the random access procedure. This is because, as described above, the larger the subcarrier spacing, the greater the influence of the changed TA value. For example, the subcarrier spacing of the terminal and the base station during the random access procedure at a carrier frequency of 6 GHz or above may be limited to a subcarrier spacing of 60 kHz or less. Alternatively, during the random access procedure, an extended cyclic prefix (CP) may be used rather than a normal CP, for a high subcarrier spacing (e.g., 120 kHz or more).

As described above, when the terminal transmits the Msg3 by applying the TA received through the RAR, and the actual TA becomes different from the TA applied to the transmission of the Msg3 due to the movement of the base station or the terminal, it may be difficult for the base station to recover the corresponding Msg3. Therefore, when the terminal transmits the Msg3, the TA change (ΔT) may be additionally reflected in addition to the application of the TA received through the RAR. That is, the terminal may change the TA applied to the transmission of the Msg3 from (common TA+differential delay value+TAoffset) to (common TA+differential delay value+TAoffset+ΔT).

The terminal may apply (common TA+differential delay value+TAoffset+ΔT) to the transmission of the Msg3 when attempting the random access again after the previous random access procedure has failed. In this case, ΔT may be estimated as follows. There are a reception time (t1) and a corresponding differential delay (d1) of the RAR received in the previous random access procedure that has failed, and a reception time (t2) and a corresponding differential delay (d2) of the RAR received in the reattempted random procedure, the change ΔT of the TA over time may be estimated as (d2−d1)/(t2−t1). Therefore, it may be possible to calculate ΔT at the time point at which the Msg3 is transmitted again and apply (common TA+differential delay value+TAoffset+ΔT) to the transmission of the Msg3.

Alternatively, if there are reception time points of SS/PBCH blocks transmitted with a specific periodicity or estimated time synchronization values of the corresponding SS/PBCH blocks, similarly to the above-described method, the TA change ΔT may be estimated according to a difference between the reception time point (or, estimated time synchronization value) of the previous SS/PBCH block and the reception time point (or, estimated time synchronization value) of the current SS/PBCH block. In other words, the TA change ΔT may be estimated using the reception time point (d1, d2) of the SS/PBCH blocks and the periodicity (t2−t1) of the SS/PBCH blocks.

Alternatively, when the terminal receives the common Doppler shift, ΔT reflected at the time when the Msg3 is transmitted may be obtained by using the common Doppler shift. However, in this case, since the terminal cannot know whether ΔT is a positive value or a negative value only by using the common Doppler shift, the terminal may use at least one of the two methods described above to determine whether ΔT is a positive value or a negative value.

Alternatively, a rate of change per hour (ΔT) may be tabulated as several values, and configured through a higher layer parameter (e.g., RRC or MAC-CE) of the SIB1 or OSI. The base station may signal a specific value of them to the terminal by using an index through a higher layer parameter (RRC or MAC CE), DCI, or the RAR. Alternatively, the base station may signal a specific value of ΔT directly to the terminal through a higher layer parameter (RRC or MAC CE), DCI, or the RAR. In order to inform ΔT through the DCI or the RAR in the step of transmitting the RAR to the terminal, the base station may estimate the rate of change per hour of the terminal based on the PRACH preamble transmitted by the terminal.

Apparatus Performing the Method According to the Present Disclosure

FIG. 5 is a block diagram illustrating a configuration of an apparatus for performing a timing synchronization method for long-distance communication according to an exemplary embodiment of the present disclosure.

The apparatus illustrated in FIG. 5 may be a communication node (terminal or base station) for performing the methods according to the exemplary embodiments of the present disclosure.

Referring to FIG. 5, a communication node 500 may include at least one processor 510, a memory 520, and a transceiver 530 connected to a network to perform communication. In addition, the communication node 500 may further include an input interface device 540, an output interface device 550, a storage device 560, and the like. The components included in the communication node 500 may be connected by a bus 570 to communicate with each other. However, each component included in the communication node 500 may be connected to the processor 510 through a separate interface or a separate bus instead of the common bus 570. For example, the processor 510 may be connected to at least one of the memory 520, the transceiver 530, the input interface device 540, the output interface device 550, and the storage device 560 through a dedicated interface.

The processor 510 may execute at least one instruction stored in at least one of the memory 520 and the storage device 560. The processor 510 may refer to a central processing unit (CPU), a graphics processing unit (GPU), or a dedicated processor on which the methods according to the exemplary embodiments of the present invention are performed. Each of the memory 520 and the storage device 560 may be configured as at least one of a volatile storage medium and a nonvolatile storage medium. For example, the memory 520 may be configured with at least one of a read only memory (ROM) and a random access memory (RAM).

The exemplary embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the exemplary embodiments of the present disclosure and their advantages have been described in detail, it should be understood that various changes, substitutions and alterations may be made herein without departing from the scope of the present disclosure.

What is claimed is:

1. A timing synchronization method performed in a terminal belonging to a mobile communication network, the timing synchronization method comprising:
receiving information on a common delay of a service link between the terminal and a base station from the base station;
transmitting a physical random access channel (PRACH) preamble to the base station by reflecting the common delay with respect to a random access channel (RACH) occasion associated with a synchronization signal/physical broadcast channel (SS/PBCH) block received from the base station;
receiving a first random access response (RAR) including a timing adjustment value reflecting a differential delay between the terminal and the base station from the base station; and
performing uplink transmission to the base station by reflecting the common delay and the timing adjustment value.

2. The timing synchronization method according to claim 1, wherein the common delay is determined based on at least one of a shortest distance between the terminal and the base station in coverage of the base station to which the terminal belongs, an average distance between the terminal and the base station in the coverage, a longest distance between the terminal and the base station in the coverage, a point where a signal-to-noise ratio (SNR) of a signal transmitted from the base station is highest in the coverage, a point where an azimuth angle of a beam transmitted to the base station in the coverage is 0°, and a center point of the beam.

3. The timing synchronization method according to claim 1, wherein the timing adjustment value additionally reflects a timing offset TAoffset in addition to the differential delay.

4. The timing synchronization method according to claim 1, wherein the information on the common delay is configured as a value specific to the base station, a value specific to a cell of the base station, or a value specific to a beam of the base station.

5. The timing synchronization method according to claim 1, wherein the information on the common delay is received as included in a master information block (MIB), system information block 1 (SIB1), other system information (OSI), or a newly defined SIB.

6. The timing synchronization method according to claim 1, wherein the receiving of the information on the common delay comprises:
receiving table-type information including at least one value of the common delay from the base station through higher layer signaling; and
receiving index information indicating one common delay value among the at least one value of the common delay from the base station.

7. The timing synchronization method according to claim 1, wherein the uplink transmission is a Msg3 of a 4-step RACH procedure, and the terminal adjusts a time point of the uplink transmission based on a difference between a timing adjustment value received through a previous RAR different from the first RAR and the timing adjustment value received through the first RAR.

8. The timing synchronization method according to claim 1, wherein the mobile communication network is a non-terrestrial network (NTN), and the base station is a satellite base station or an unmanned aerial vehicle (UAV) on-board base station.

9. A timing synchronization method performed in a base station belonging to a mobile communication network, the timing synchronization method comprising:
transmitting information on a common delay of a service link between the base station and a terminal to the terminal;
receiving a physical random access channel (PRACH) preamble from the terminal, the PRACH preamble being transmitted by reflecting the common delay with respect to a random access channel (RACH) occasion associated with a synchronization signal/physical broadcast channel (SS/PBCH) block transmitted to the terminal;
transmitting a first random access response (RAR) including a timing adjustment value reflecting a differential delay between the terminal and the base station to the terminal; and
receiving uplink transmission from the terminal, the common delay and the timing adjustment value being reflected to the uplink transmission.

10. The timing synchronization method according to claim 9, wherein the common delay is determined based on at least one of a shortest distance between the terminal and the base station in coverage of the base station to which the terminal belongs, an average distance between the terminal and the base station in the coverage, a longest distance between the terminal and the base station in the coverage, a point where a signal-to-noise ratio (SNR) of a signal transmitted from the base station is highest in the coverage, a point where an azimuth angle of a beam transmitted to the base station in the coverage is 0°, and a center point of the beam.

11. The timing synchronization method according to claim 9, wherein the timing adjustment value additionally reflects a timing offset TAoffset in addition to the differential delay.

12. The timing synchronization method according to claim 9, wherein the information on the common delay is configured as a value specific to the base station, a value specific to a cell of the base station, or a value specific to a beam of the base station.

13. The timing synchronization method according to claim 9, wherein the information on the common delay is transmitted as included in a master information block (MIB), system information block 1 (SIB1), other system information (OSI), or a newly defined SIB.

14. The timing synchronization method according to claim 9, wherein the transmitting of the information on the common delay comprises:
transmitting table-type information including at least one value of the common delay to the terminal through higher layer signaling; and
transmitting index information indicating one common delay value among the at least one value of the common delay to the terminal.

15. The timing synchronization method according to claim 9, wherein the uplink transmission is a Msg3 of a 4-step RACH procedure, and the terminal adjusts a time point of the uplink transmission based on a difference between a timing adjustment value received through a previous RAR different from the first RAR and the timing adjustment value received through the first RAR.

16. The timing synchronization method according to claim 9, wherein the mobile communication network is a non-terrestrial network (NTN), and the base station is a satellite base station or an unmanned aerial vehicle (UAV) on-board base station.

17. A terminal belonging to a mobile communication network, the terminal comprising:
a processor; and
a memory storing at least one instruction executable by the processor,
wherein when executed by the processor, the at least one instruction causes the processor to:
receive information on a common delay of a service link between the terminal and a base station from the base station;
transmit a physical random access channel (PRACH) preamble to the base station by reflecting the common delay with respect to a random access channel (RACH) occasion associated with a synchronization signal/physical broadcast channel (SS/PBCH) block received from the base station;
receive a first random access response (RAR) including a timing adjustment value reflecting a differential delay between the terminal and the base station from the base station; and
perform uplink transmission to the base station by reflecting the common delay and the timing adjustment value.

18. The terminal according to claim 17, wherein the common delay is determined based on at least one of a shortest distance between the terminal and the base station in coverage of the base station to which the terminal belongs, an average distance between the terminal and the base station in the coverage, a longest distance between the terminal and the base station in the coverage, a point where a signal-to-noise ratio (SNR) of a signal transmitted from the base station is highest in the coverage, a point where an azimuth angle of a beam transmitted to the base station in the coverage is 0°, and a center point of the beam.

19. The terminal according to claim 17, wherein the information on the common delay is received as included in a master information block (MIB), system information block 1 (SIB1), other system information (OSI), or a newly defined SIB.

20. The terminal according to claim 17, wherein the uplink transmission is a Msg3 of a 4-step RACH procedure, and the terminal adjusts a time point of the uplink transmission based on a difference between a timing adjustment value received through a previous RAR different from the first RAR and the timing adjustment value received through the first RAR.
